(19) United States
(12) Patent Application Publication
(10) Pub. No.: US 2023/0284190 A1
(43) Pub. Date: Sep. 7, 2023

(54) CONTROL INFORMATION THAT SCHEDULES OR ACTIVATES MULTIPLE TRANSMISSIONS

(71) Applicant: Lenovo (Singapore) Pte. Ltd., New Tech Park (SG)

(72) Inventors: Ankit Bhamri, Rödermark (DE); Alexander Johann Maria Golitschek Edler von Elbwart, Darmstadt (DE); Karthikeyan Ganesan, Kronberg im Taunus (DE); Hyejung Jung, Northbrook, IL (US); Ali Ramadan Ali, Kraiburg am Inn (DE)

(21) Appl. No.: 18/013,712

(22) PCT Filed: Jun. 28, 2021
(86) PCT No.: PCT/IB2021/055778

§ 371 Date: Dec. 29, 2022

Related U.S. Application Data
(60) Provisional application No. 63/045,704, filed on Jun. 29, 2020.

(51) Int. Cl. H04W 72/0446; H04W 72/231

(52) U.S. Cl. CPC H04W 72/0446; H04W 72/231

(57) ABSTRACT

Apparatuses, methods, and systems are disclosed for control information that schedules or activates multiple transmissions. One method (1200) includes receiving (1202) user equipment specific signaling from a device. The user equipment specific signaling comprises a control information format that dynamically indicates a set of parameters that schedule or activate at least two transmissions between the user equipment and the device; and the at least two transmissions comprise: a first transmission having a first transmission link direction from the user equipment to the device; and a second transmission having a second transmission link direction from the device to the user equipment.

### CROSS-REFERENCE TO RELATED APPLICATIONS

This application claims priority to U.S. Patent Application Ser. No. 63/045,704 entitled “APPARATUSES, METHODS, AND SYSTEMS FOR A NEW UNIFIED DCI FORMAT DESIGN AND TIME-DOMAIN MULTIPLEXING FOR DL/UL TRANSMISSIONS/RETRANSMISSIONS/REPETITIONS WITH HIGH SUBCARRIER SPACING” and filed on Jun. 29, 2020 for Ankit Bhamri, which is incorporated herein by reference in its entirety.

### FIELD

The subject matter disclosed herein relates generally to wireless communications and more particularly relates to control information that schedules or activates multiple transmissions.

### BACKGROUND

In certain wireless communications networks, multiple control information formats may be used for multiple transmissions. Such networks may be inefficient.

### BRIEF SUMMARY

Methods for control information that schedules or activates multiple transmissions are disclosed. Apparatuses and systems also perform the functions of the methods. One embodiment of a method includes receiving user equipment specific signaling from a device. The user equipment specific signaling comprises a control information format that dynamically indicates a set of parameters that schedule or activate at least two transmissions between the user equipment and the device; and the at least two transmissions comprise: a first transmission having a first transmission link direction from the user equipment to the device; and a second transmission having a second transmission link direction from the device to the user equipment.

One apparatus for control information that schedules or activates multiple transmissions includes a receiver that receives user equipment specific signaling from a device. The user equipment specific signaling comprises a control information format that dynamically indicates a set of parameters that schedule or activate at least two transmissions between the user equipment and the device; and the at least two transmissions comprise: a first transmission having a first transmission link direction from the user equipment to the device; and a second transmission having a second transmission link direction from the device to the user equipment.

Another embodiment of a method for control information that schedules or activates multiple transmissions includes transmitting user equipment specific signaling from a device. The user equipment specific signaling comprises a control information format that dynamically indicates a set of parameters that schedule or activate at least two transmissions between the user equipment and the device; and the at least two transmissions comprise: a first transmission having a first transmission link direction from the user equipment to the device; and a second transmission having a second transmission link direction from the device to the user equipment.

Another apparatus for control information that schedules or activates multiple transmissions includes a transmitter that transmits user equipment specific signaling from the device. The user equipment specific signaling comprises a control information format that dynamically indicates a set of parameters that schedule or activate at least two transmissions between the user equipment and the device; and the at least two transmissions comprise: a first transmission having a first transmission link direction from the user equipment to the device; and a second transmission having a second transmission link direction from the device to the user equipment.

Another embodiment of a method for control information that schedules or activates multiple transmissions includes receiving user equipment specific signaling from a device. The user equipment specific signaling comprises a control information format that dynamically indicates scheduling information that schedules or activates transmission of a first transport block across a first plurality of slots, reception of a second transport block across a second plurality of slots, or a combination thereof.

Another apparatus for control information that schedules or activates multiple transmissions includes a receiver that receives user equipment specific signaling from a device. The user equipment specific signaling comprises a control information format that dynamically indicates scheduling information that schedules transmission of a first transport block across a first plurality of slots, reception of a second transport block across a second plurality of slots, or a combination thereof.

Another embodiment of a method for control information that schedules or activates multiple transmissions includes transmitting user equipment specific signaling from a device. The user equipment specific signaling comprises a control information format that dynamically indicates scheduling information that schedules or activates transmission of a first transport block across a first plurality of slots, reception of a second transport block across a second plurality of slots, or a combination thereof.

Another apparatus for control information that schedules or activates multiple transmissions includes a transmitter that transmits user equipment specific signaling from the device. The user equipment specific signaling comprises a control information format that dynamically indicates scheduling information that schedules transmission of a first transport block across a first plurality of slots, reception of a second transport block across a second plurality of slots, or a combination thereof.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for control information that schedules or activates multiple transmissions;

FIG. 2 is a schematic block diagram illustrating one embodiment of an apparatus that may be used for control information that schedules or activates multiple transmissions;

FIG. 3 is a schematic block diagram illustrating one embodiment of an apparatus that may be used for control information that schedules or activates multiple transmissions;

FIG. 4 is a graph diagram illustrating one embodiment of a maximum number of monitored PDCCH candidates per slot and per serving cell;

FIG. 5 is a schematic block diagram illustrating one embodiment of DL and UL scheduling by a single instance of a unified DCI format;

FIG. 6 is a schematic block diagram illustrating one embodiment of a single DL TB and a single UL TB across multiple slots;

FIG. 7 is a schematic block diagram illustrating one embodiment of DM-RS for a single TB across multiple slots;

FIG. 8 is a schematic block diagram illustrating one embodiment of multiple DL TBs and multiple UL TBs across multiple slots;

FIG. 9 is a schematic block diagram illustrating another embodiment of multiple DL TBs and multiple UL TBs across multiple slots;

FIG. 10 is a schematic block diagram illustrating one embodiment of a combination of a single UL TB and multiple DL TBs across multiple slots;

FIG. 11 is a schematic block diagram illustrating one embodiment of sidelink communications;

FIG. 12 is a flow chart diagram illustrating one embodiment of a method for control information that schedules or activates multiple transmissions;

FIG. 13 is a flow chart diagram illustrating another embodiment of a method for control information that schedules or activates multiple transmissions;

FIG. 14 is a flow chart diagram illustrating yet another embodiment of a method for control information that schedules or activates multiple transmissions; and

FIG. 15 is a flow chart diagram illustrating yet another embodiment of a method for control information that schedules or activates multiple transmissions.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (anon-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

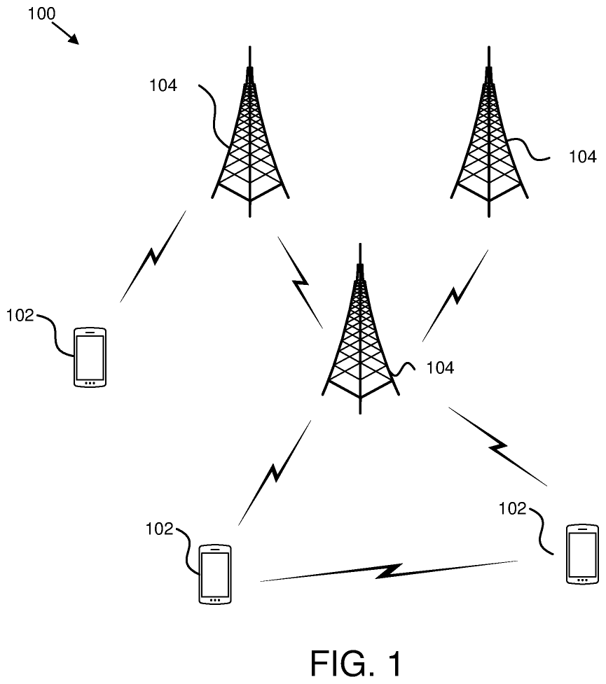

FIG. 1 depicts an embodiment of a wireless communication system 100 for control information that schedules or activates multiple transmissions. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may receive user equipment specific signaling from a device. The user equipment specific signaling comprises a control information format that dynamically indicates a set of parameters that schedule or activate at least two transmissions between the user equipment and the device; and the at least two transmissions comprise: a first transmission having a first transmission link direction from the user equipment to the device; and a second transmission having a second transmission link direction from the device to the user equipment. Accordingly, the remote unit 102 may be used for control information that schedules or activates multiple transmissions.

In certain embodiments, a network unit 104 may transmit user equipment specific signaling from a device. The user equipment specific signaling comprises a control information format that dynamically indicates a set of parameters that schedule or activate at least two transmissions between the user equipment and the device; and the at least two transmissions comprise: a first transmission having a first transmission link direction from the user equipment to the device; and a second transmission having a second transmission link direction from the device to the user equipment. Accordingly, the network unit 104 may be used for control information that schedules or activates multiple transmissions.

In some embodiments, a remote unit 102 may receive user equipment specific signaling from a device. The user equipment specific signaling comprises a control information format that dynamically indicates scheduling information that schedules transmission of a first transport block across a first plurality of slots, reception of a second transport block across a second plurality of slots, or a combination thereof. Accordingly, the remote unit 102 may be used for control information that schedules or activates multiple transmissions.

In various embodiments, a network unit 104 may transmit user equipment specific signaling from a device. The user equipment specific signaling comprises a control information format that dynamically indicates scheduling information that schedules transmission of a first transport block across a first plurality of slots, reception of a second transport block across a second plurality of slots, or a combination thereof. Accordingly, the network unit 104 may be used for control information that schedules or activates multiple transmissions.

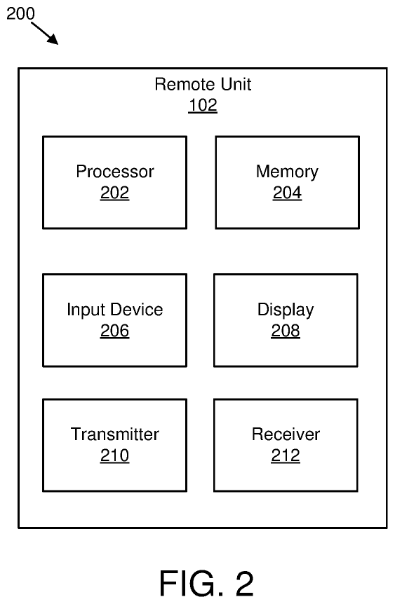

FIG. 2 depicts one embodiment of an apparatus 200 that may be used for control information that schedules or activates multiple transmissions. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

The receiver 212 may receive user equipment specific signaling from a device. The user equipment specific signaling comprises a control information format that dynamically indicates a set of parameters that schedule or activate at least two transmissions between the user equipment and the device; and the at least two transmissions comprise: a first transmission having a first transmission link direction from the user equipment to the device; and a second transmission having a second transmission link direction from the device to the user equipment.

The receiver 212 may receive user equipment specific signaling from a device. The user equipment specific signaling comprises a control information format that dynamically indicates scheduling information that schedules transmission of a first transport block across a first plurality of slots, reception of a second transport block across a second plurality of slots, or a combination thereof.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

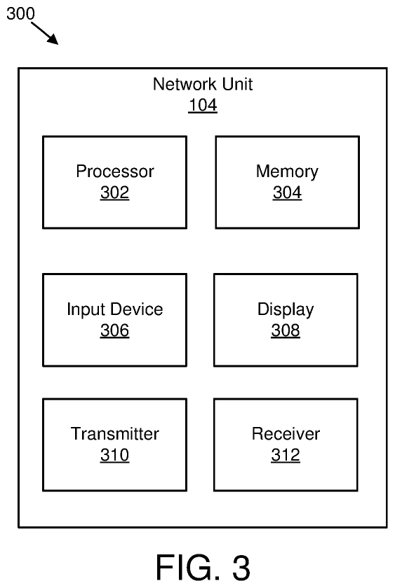

FIG. 3 depicts one embodiment of an apparatus 300 that may be used for control information that schedules or activates multiple transmissions. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

The transmitter 310 may transmit user equipment specific signaling from the device. The user equipment specific signaling comprises a control information format that dynamically indicates a set of parameters that schedule or activate at least two transmissions between the user equipment and the device; and the at least two transmissions comprise: a first transmission having a first transmission link direction from the user equipment to the device; and a second transmission having a second transmission link direction from the device to the user equipment.

The transmitter 310 may transmit user equipment specific signaling from the device. The user equipment specific signaling comprises a control information format that dynamically indicates scheduling information that schedules transmission of a first transport block across a first plurality of slots, reception of a second transport block across a second plurality of slots, or a combination thereof.

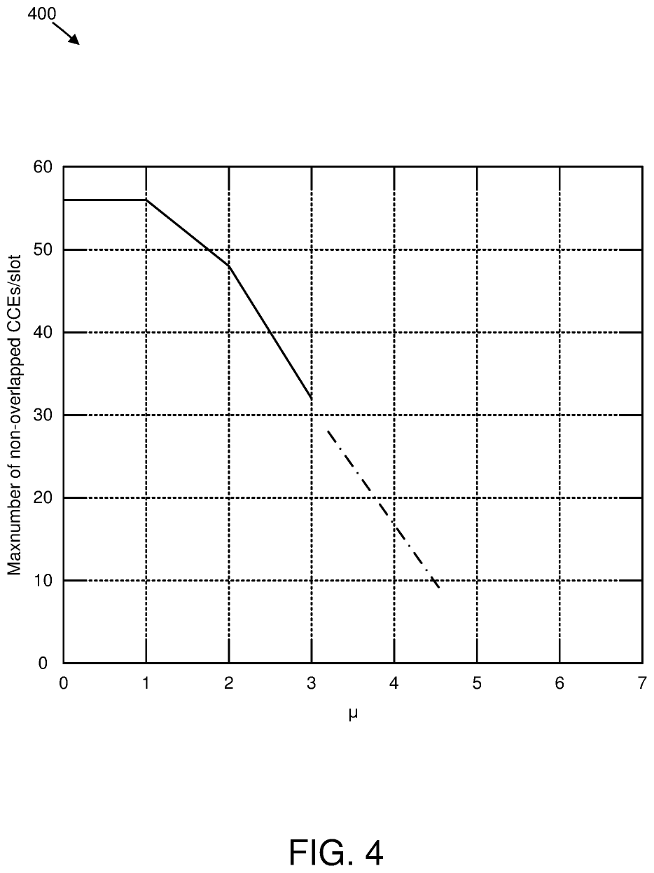

In certain embodiments, physical downlink control channel (“PDCCH”) monitoring and/or timeline may be determined if higher subcarrier spacing values (e.g., such as 480 kHz, 960 kHz, and beyond) are used for beyond 52.6 GHz. In such embodiments, if high subcarrier spacing (“SCS”) is used, PDCCH monitoring may be frequent due to shorter slot length duration. FIG. 4 illustrates that a PDCCH monitoring capability reduces significantly with increased subcarrier spacing. For beyond 52.6 GHz, with SCS values such as 240, 480, 960 kHz, monitoring capability will likely further be reduced. In some embodiments, a need of having frequent PDCCH monitoring for a user equipment (“UE”) may be alleviated.

In various embodiments, a gNB may configure a UE to monitor a similar number of PDCCH candidates and/or non-overlapped control channel elements (“CCEs”) per given absolute time duration for different subcarrier spacings to maintain similar PDCCH blind decoding complexity for the different subcarrier spacings. For example, the UE may be configured to monitor 20 PDCCH candidates per serving cell and per 0.125 ms duration both for 120 kHz SCS and for 240 kHz SCS. In such embodiments, the number of PDCCH candidates to be monitored per slot for higher SCS (e.g., 240 kHz) becomes limited, which may result in PDCCH blocking.

In certain embodiments, a downlink control information (“DCI”) format that can schedule one or more physical uplink shared channels (“PUSCHs”), one or more physical downlink shared channels (“PDSCHs”), and/or one or more PDSCHs and physical uplink shared channels (“PUSCHs”) with reuse of as many DCI fields as possible may alleviate a potential PDCCH blocking issue for high SCS.

FIG. 4 is a graph diagram 400 illustrating one embodiment of a maximum number of monitored PDCCH candidates per slot and per serving cell (e.g., maximum number of non-overlapped CCEs per slot).

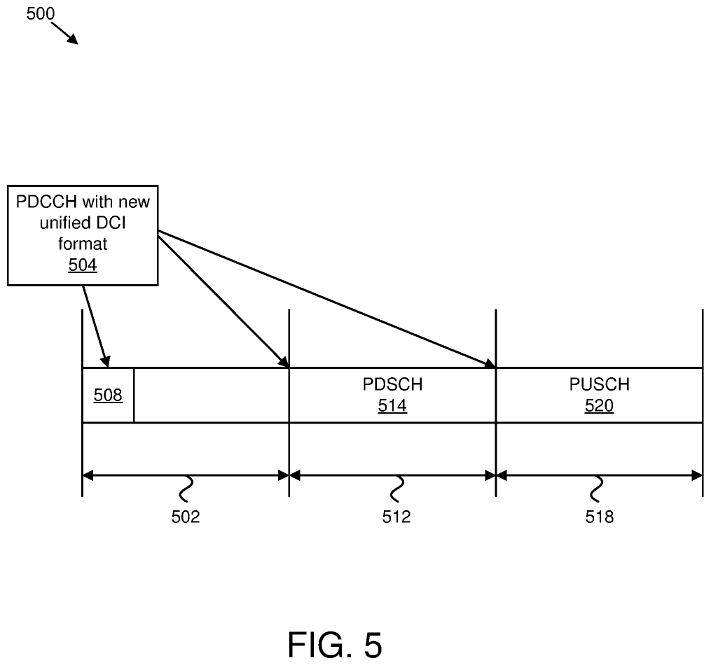

In some embodiments, a signaling mechanism may be used to schedule, configure, and/or activate transmissions (e.g., including retransmissions and repetitions) for downlink, uplink, and sidelink across one or more slots. In such embodiments, a UE determines scheduling information and corresponding parameters for multiple directions (e.g., downlink (“DL”), uplink (“UL”), sidelink (“SL”)) by receiving a single instance of a control information format (e.g., anew DCI format). In various embodiments, a unified DCI format may be used to schedule both DL and UL between a given UE and a gNB. In such embodiments, the UE is expected to receive all the parameters required for receiving PDSCH and transmitting PUSCH on dedicated resources (e.g., non-overlapping) indicated using a single unified DCI format. FIG. 5 illustrates one example of such embodiments in which the UE receives a single instance of a DCI format in slot N and schedules a DL transmission (e.g., PDSCH) in slot N+1 and an UL transmission (e.g., PUSCH) for slot N+2.

Specifically, FIG. 5 is a schematic block diagram 500 illustrating one embodiment of DL and UL scheduling by a single instance of a unified DCI format. In a first slot 502 (e.g., slot N), a PDCCH 504 transmission with new unified DCI format is transmitted in 508. In a second slot 512 (e.g., slot N+1), a PDSCH 514 transmission is scheduled by the PDCCH 504. Moreover, in a third slot 518 (e.g., slot N+2), a PUSCH 520 transmission is scheduled by the PDCCH 504.

In various embodiments, time-domain multiplexing of single or multiple new transmissions (e.g., transport blocks (“TBs”)) and/or repetitions of a sub-set or all TBs and/or retransmissions of one or more previously transmitted TBs across multiple slots for both UL and DL.

Certain embodiments described herein may have a benefit of enabling reduced PDCCH monitoring for a UE as that UE may not be required to receive separate DCI's for scheduling DL and UL across one or more slots.

In some embodiments, time-domain PDSCH and/or PUSCH scheduling may be made with a new unified DCI format. In various embodiments, there may be a single TB with multi-slot scheduling for PDSCH and/or PUSCH.

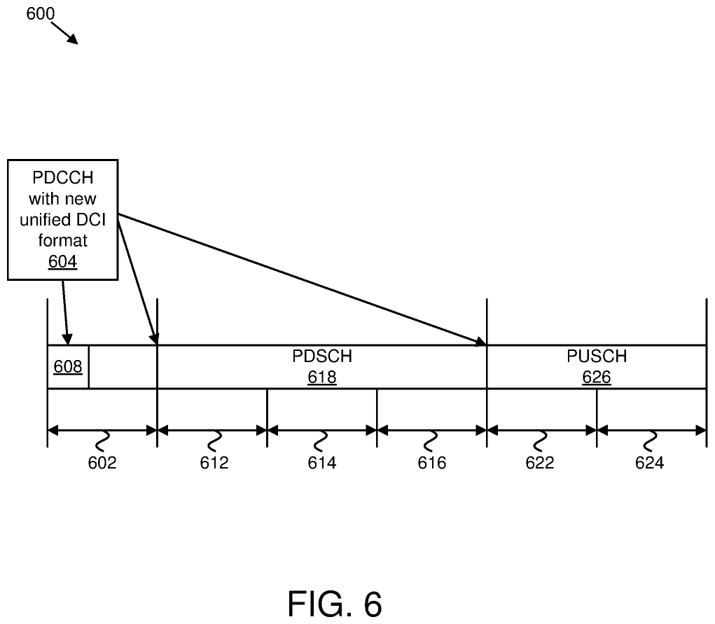

In certain embodiments, a UE is configured and/or indicated to receive a single DL TB across more than one slot from a gNB and/or transmit a single UL TB across more than one slot to the gNB by a new unified DCI format. One example of such embodiments is shown in FIG. 6, where a single DL TB is scheduled for transmission to a UE across 3 slots and a single UL TB is scheduled for transmission from the UE across 2 slots.

Specifically, FIG. 6 is a schematic block diagram 600 illustrating one embodiment of a single DL TB and a single UL TB across multiple slots. In a first slot 602 (e.g., slot N), a PDCCH 604 transmission with new unified DCI format is transmitted in 608. In a second slot 612 (e.g., slot N+1), third slot 614 (e.g., slot N+2), and fourth slot 616 (e.g., slot N+3), a PDSCH 618 transmission is scheduled by the PDCCH 604. Moreover, in a fifth slot 622 (e.g., slot N+4) and in a sixth slot 624 (e.g., slot N+5), a PUSCH 626 transmission is scheduled by the PDCCH 604.

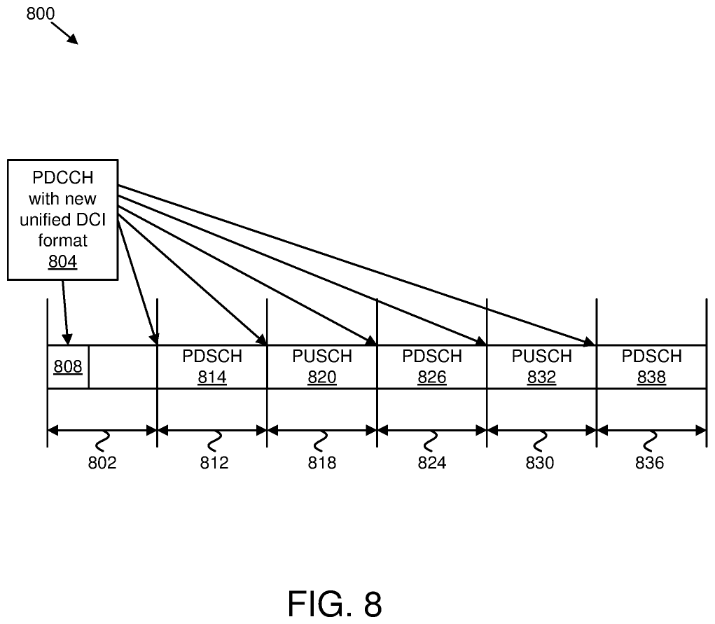

In various embodiments, transmission and/or reception of a single TB across multiple slots is indicated to the UE by a dedicated field in a new unified DCI format that enables or disables single TB transmission across multiple slots. This dedicated field may be a single field applied to both DL and UL directions or a separate field for each direction. In certain embodiments, an indication is implicit (e.g., no dedicated field in a new unified DCI format) to indicate single TB transmission across multiple slots. In such embodiments, a start symbol position within a slot (“S”) and duration of transmission in symbols (“L”) are indicated to allow transmission across more than one slot. For example, with S=0 and L=56, it may be implied that there is a single TB transmission across 4 slots, since 56 symbols span 4 slots. S and L values may be a single set applicable to both DL and UL or separately indicated for both DL and UL. Alternatively, transmission of single transport block across multiple slots can also be indicated by a factor that indicates the number of slots for multi-slot single TB transmission. In such embodiments, repetition factor can be used to imply the number of slots for indicating single TB transmission across multiple slots. In certain embodiments, a field that enables or disables single TB transmission across multiple slots may apply for UL-DL-UL-DL or DL-UL-DL-UL as shown in FIG. 8. In certain embodiments, only UL transmission with single TB across multiple slots can be scheduled by a single DCI. Alternatively, in certain embodiments, only DL transmission with single TB across multiple slots can be scheduled by a single DCI. In various embodiments, multiple slots for single TB transmission are contiguous such as UL-UL-UL. In some other embodiments, multiple slots for single TB transmission are non-contiguous such as UL-DL-UL.

In some embodiments, if a single TB is scheduled across multiple slots, then the TB may be segmented into multiple code blocks (“CBs”) such that each CB is transmitted within one slot to allow single CB decoding after receiving a single slot out of multiple slots. In various embodiments, if a TB is segmented into multiple code blocks, CBs belonging to the same code block group (“CBG”) may be transmitted within one slot to facilitate an early determination of hybrid automatic repeat request (“HARQ”) acknowledgment (“ACK”) (“HARQ-ACK”) feedback for the CBs in the same CBG.

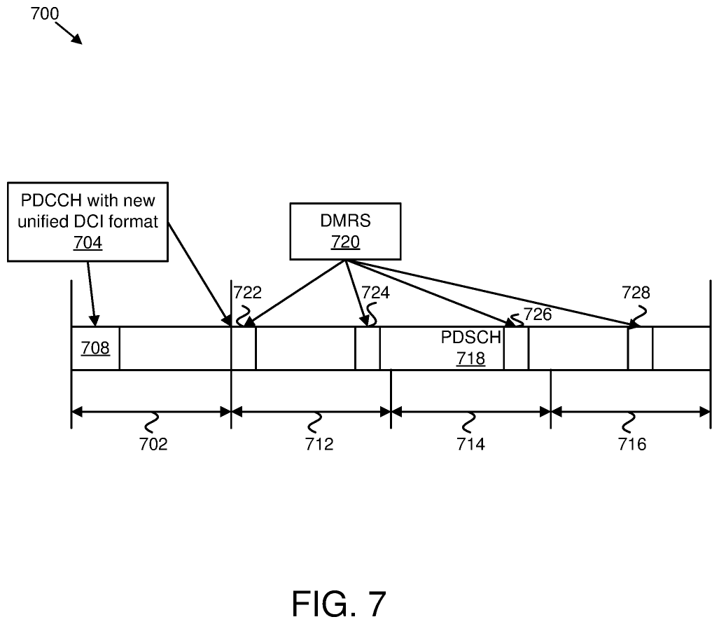

In certain embodiments, if a single TB is scheduled across multiple slots, then a new demodulation (“DM”) reference signal (“RS”) (“DM-RS”) and/or phase tracking (“PT”) RS (“PT-RS”) configuration may be applied across the entire length of transmission to enable channel estimation and/or phase noise compensation by interpolation between the slots. In such embodiments, depending upon the number of slots scheduled for single TB transmission, a front-loaded DM-RS is configured at the beginning of the first slot for transmission and additional DM-RS could be indicated and/or configured such that they are equally distant (or almost) across all the slots that could allow for more flexibility and potentially optimal DM-RS separation in time-domain. An example illustration of 4 DM-RS across three slots for PDSCH is shown in FIG. 7. A similar embodiment may be used for PUSCH as well.

FIG. 7 is a schematic block diagram 700 illustrating one embodiment of DM-RS for a single TB across multiple slots. In a first slot 702 (e.g., slot N), a PDCCH 704 transmission with new unified DCI format is transmitted in 708. In a second slot 712 (e.g., slot N+1), third slot 714 (e.g., slot N+2), and fourth slot 716 (e.g., slot N+3), a PDSCH 718 transmission is scheduled by the PDCCH 704. Moreover, DM RS (“DMRS”) 720 transmissions are transmitted in 722, 724, 726, and 728.

In some embodiments, a front-loaded DM-RS configuration may be applied across all slots (e.g., there is 1 or 2-symbol DM-RS at the beginning of all slots and any additional DM-RS within the slots).

In various embodiments in which there is a DM-RS configuration across multiple slots, an offset for shifting DM-RS in a time-domain may be configured and/or indicated to allow more flexible effective patterns for inter-slot implementation. For example, an offset of k symbols per slot may be configured and/or indicated such that if the DM-RS occupy symbols #1 and #4 in slot N+1, they occupy symbols #1+k and #4+k in slot N+2, then symbols #1+2k and #4+2k in slot N+3, and so forth. In certain embodiments, if a shifted DM-RS would end up in a symbol number greater than 14, the corresponding DM-RS symbol may be dropped.

In some embodiments, there may be multiple TBs with multi-slot scheduling for PDSCH and/or PUSCH.

In various embodiments, a UE is configured and/or indicated to receive multiple DL TBs across more than one slot from a gNB and/or may transmit multiple UL TBs across more than one slot to the gNB by a new unified DCI format. One example of such embodiments is shown in FIG. 8, where three DL TBs are scheduled for transmission to UE across 3 slots and two UL TBs are scheduled for transmission from UE across 2 slots. Such alternating DL and/or UL may be good for ultra-reliable low latency communication (“URLLC”).

Specifically, FIG. 8 is a schematic block diagram 800 illustrating one embodiment of multiple DL TBs and multiple UL TBs across multiple slots. In a first slot 802 (e.g., slot N), a PDCCH 804 transmission with new unified DCI format is transmitted in 808. In a second slot 812 (e.g., slot N+1), a PDSCH 814 transmission (e.g., DL TB 1) is scheduled by the PDCCH 804. Moreover, in a third slot 818 (e.g., slot N+2), a PUSCH 820 transmission (e.g., UL TB 1) is scheduled by the PDCCH 804. Further, in a fourth slot 824 (e.g., slot N+3), a PDSCH 826 transmission (e.g., DL TB 2) is scheduled by the PDCCH 804. In a fifth slot 830 (e.g., slot N+4), a PUSCH 832 transmission (e.g., UL TB 2) is scheduled by the PDCCH 804. Moreover, in a sixth slot 836 (e.g., slot N+5), a PDSCH 838 transmission (e.g., DL TB 3) is scheduled by the PDCCH 804.

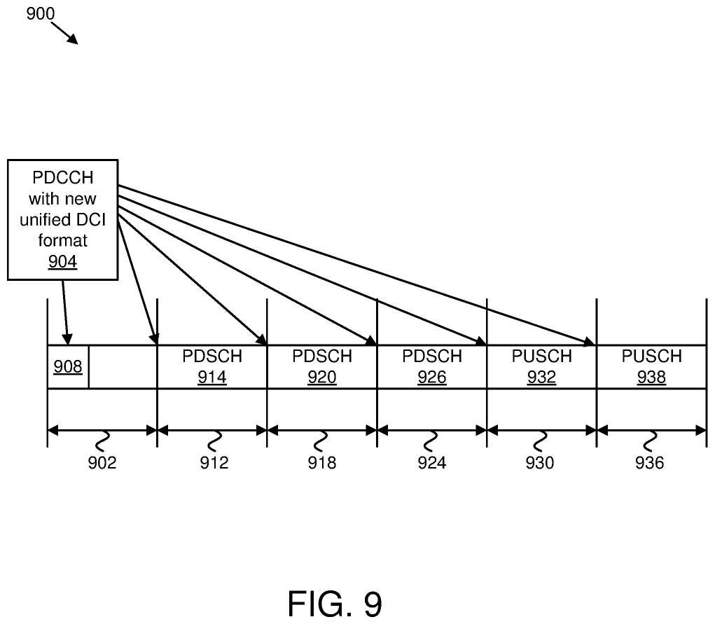

In certain embodiments, multiplexing DL and UL slots may be performed as shown in FIG. 9, where multiple TBs across multiple slots are first allocated to DL and followed by multiple TBs across multiples slots for UL. Such embodiments may be beneficial for unlicensed operation to reduce a number of required listen before talks (“LBTs”) if switching from DL to UL or UL to DL.

Specifically, FIG. 9 is a schematic block diagram 900 illustrating another embodiment of multiple DL TBs and multiple UL TBs across multiple slots. In a first slot 902 (e.g., slot N), a PDCCH 904 transmission with new unified DCI format is transmitted in 908. In a second slot 912 (e.g., slot N+1), a PDSCH 914 transmission (e.g., DL TB 1) is scheduled by the PDCCH 904. Moreover, in a third slot 918 (e.g., slot N+2), a PDSCH 920 transmission (e.g., DL TB 2) is scheduled by the PDCCH 904. Further, in a fourth slot 924 (e.g., slot N+3), a PDSCH 926 transmission (e.g., DL TB 3) is scheduled by the PDCCH 904. In a fifth slot 930 (e.g., slot N+4), a PUSCH 932 transmission (e.g., UL TB 1) is scheduled by the PDCCH 904. Moreover, in a sixth slot 936 (e.g., slot N+5), a PUSCH 938 transmission (e.g., UL TB 2) is scheduled by the PDCCH 904.

In some embodiments, a single set of S, L, and number of TBs to be transmitted and/or received may be indicated to a UE and a sequence of multiplexing (e.g., between DL and UL) is either fixed or semi-statically indicated or dynamically indicated from a configured set of multiplexing patterns. For indicating a number of TBs to be transmitted, implicit indication such as a number of start and length indicator values (“SLIVs”) may be used, and/or the number of SLIVs may be explicitly indicated as part of a time domain resource assignment (“TDRA”) table, a separate dedicated field in DCI, or by higher layer signaling such as radio resource control (“RRC”) signaling.

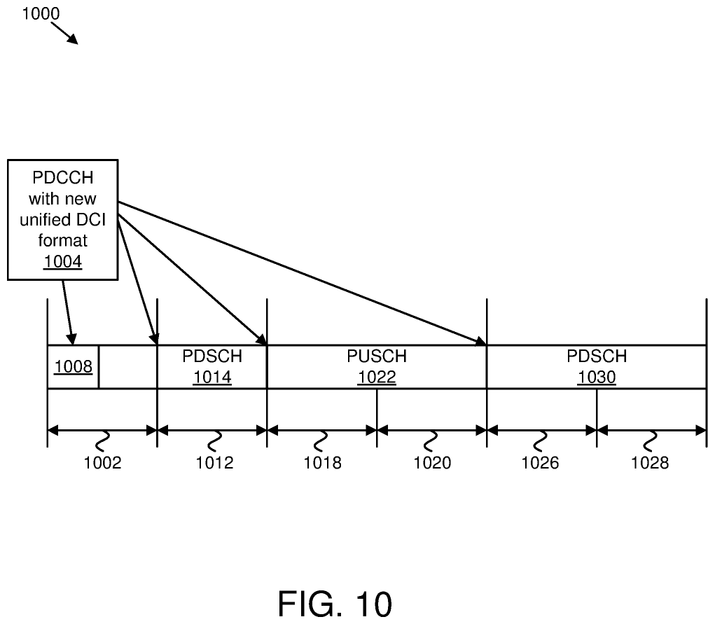

In various embodiments, separate sets of S, L, and number of TBs to be transmitted and/or received may be indicated to a UE for DL and UL. In one example of such embodiments, if separate sets of S, L, and number of TBs are allowed to be indicated for DL and UL, then a combination of single TBs across multiple slots and multiple TBs across multiple slots may be realized as illustrated in one example in FIG. 10. In various embodiments, a single set of S, L and number of slots to be scheduled are indicated to the UE.

Specifically, FIG. 10 is a schematic block diagram 1000 illustrating one embodiment of a combination of a single UL TB and multiple DL TBs across multiple slots. In a first slot 1002 (e.g., slot N), a PDCCH 1004 transmission with new unified DCI format is transmitted in 1008. In a second slot 1012 (e.g., slot N+1), a PDSCH 1014 transmission (e.g., DL TB 1) is scheduled by the PDCCH 1004. Moreover, in a third slot 1018 (e.g., slot N+2) and a fourth slot 1020 (e.g., slot N+3), a PUSCH 1022 transmission (e.g., UL TB 1) is scheduled by the PDCCH 1004. Further, in a fifth slot 1026 (e.g., slot N+4) and in a sixth slot 1028 (e.g., slot N+5), a PDSCH 1030 transmission (e.g., DL TB 2) is scheduled by the PDCCH 1004.

In certain embodiments, there may be a combination of a new TB, a retransmission of previous TBs, and/or repetitions of new TBs with multi-slot scheduling for PDSCH and/or PUSCH.

In some embodiments, if a UE is configured and/or indicated to receive multiple and/or single DL TBs across more than one slot from a gNB and/or also transmit multiple and/or single UL TBs across more than one slot to the gNB by a new unified DCI format, then the UE may also be indicated to multiplex repetitions of some or all new TBs and/or multiplex retransmissions of some or all previously transmitted TBs.

In various embodiments, separate sets of S, L, and a number of TBs may be indicated for DL and UL. In such embodiments, for corresponding TBs in DL and UL, separate new data indicator (“NDI”) bits may be indicated. It may be indicated whether each of the TBs is new transmission or a retransmission. Moreover, in such embodiments, a number of repetitions may be configured and/or indicated for each of the TBs separately or two values for each of UL (e.g., same repetition number for all TBs in UL) and DL (e.g., same repetition number for all TBs in DL), or a single value for both UL and DL.

In certain embodiments, if a single TB is transmitted for one direction (e.g., DL) and multiple TBs are transmitted for the other direction (e.g., UL), then a single bit of NDI may be indicated for DL, and multiple NDI bits can be indicated for UL.

In some embodiments, a DL DCI field may contain information related to an UL DCI transmission. The information may include an UL DCI format and/or size, an aggregation level, a control resource set (“CORESET”) identifier (“ID”), a search space ID, a slot number, a slot offset (e.g., offset from DL DCI) so that a UE does not perform blind decoding to decode UL DCI and the UE may skip the DCI monitoring in the remaining slot until the slot where it receives UL DCI. In such embodiments, the CORESET ID and/or search space ID may not be indicated while the UE may assume that the UL DCI is scheduled in the same CORESET and/or search space as that of DL DCI.

In various embodiments, there may be fields defined for a new unified DCI format. In certain embodiments, a DCI format and/or DL and/or UL direction identifiers may be used.

In some embodiments, a 2-bit field is indicated in a new unified DCI format, where a codepoints of the 2-bit field may be interpreted according to Table 8.

TABLE 1
Bit field for DCI format and/or DL and/or UL direction identifier

| Bit value | Indication |
|---|---|
| 00 | Both DL and UL |
| 01 | Only DL |
| 10 | Only UL |
| 11 | Reserved |

In various embodiments, there is no bit field indicated for a DCI format and/or direction identifier. In such embodiments, a UE may assume that both UL and DL transmissions can be scheduled, depending upon a total size of a DCI format. This may mean that the UE assumes that both UL and DL transmissions are scheduled if the total size of the DCI format exceeds (or is equal to) a pre-configured or pre-determined threshold. In one example, the threshold is the size of a DCI format that schedules only DL transmission or that schedules only UL transmission (e.g., the size of DCI format 1-1 and DCI format 0-1). In another example, the threshold is configurable as a number of bits, or by configuring a reference DCI format with a size that determines the threshold.

In certain embodiments, there may be bandwidth part bandwidth part (“BWP”) switching for UL and DL. In some embodiments, a variable size bandwidth part indicator field may be indicated by a new unified DCI format with a maximum size of up to 4 bits if both DL and UL are scheduled or a maximum size up to 2 bits if either of DL or UL are scheduled. For a bit field size 4, all combinations of different BWPs indicated for UL (e.g., up to 4 BWPs) and DL (e.g., up to 4 BWPs) may be indicated for each codepoint of this bit field. In such embodiments, two separate BWPs may be indicated (e.g., first one for UL BWP and second one for DL BWP, or the other way around).

In some embodiments, if only one BWP value is indicated by a codepoint of a bit field, then a UE may assume the same BWP index is to be used for UL and DL. This may require only up to size 2 for this bit field to support up to 4 BWPs. In various embodiments, if only a single BWP index is indicated by a codepoint of a bit field and it is indicated by higher layers that dynamic BWP switching is not enabled for either DL or UL, then a BWP field in DCI may only apply to a link direction for which dynamic BWP switching is enabled. If the size of this bit field is 0, then the UE may assume that dynamic BWP switching is not enabled for both DL and UL.

In certain embodiments, there may be an antenna ports indication for UL and DL.

In some embodiments, a variable size antenna port field may be indicated by a new unified DCI format with a maximum size of up to 11 bits if both DL and UL are scheduled. For a bit field size 11, all combinations of different antenna ports indication for UL (e.g., up to 6 bits) and DL (e.g., up to 5 bits) may be indicated (e.g., for each codepoint of this bit field). Moreover, in the bit field size of 11, two separate sets of antenna ports may be indicated (e.g., first one for UL antenna ports and second one for DL antenna ports, or the other way around).

In various embodiments, only a single set of antenna ports may be indicated (e.g., same antenna port configuration for DL and UL), if at least one of the following conditions is satisfied: 1) both UL and DL use the same waveform for scheduled transmission; 2) both UL and DL use the same numerology; 3) both UL and DL have channel reciprocity (e.g., based on channel feedback); and 4) both UL and DL have a single modulation and coding scheme (“MCS”) indicated. In such embodiments, a number of bits may be less than if two sets of antenna ports are indicated.

In certain embodiments, there may be a new data indicator for UL and DL.

In some embodiments, a variable size NDI field may be indicated by a new unified DCI format with a maximum size of a sum of a maximum number of TBs for DL and UL. In such embodiments, a different size for NDI between DL and UL may be indicated if a sequence of NDI (e.g., associated with either DL or UL TB) may be inferred based on a TDRA for each TB. For example, if, for the TDRA in FIG. 10, the NDI bit field is indicated as 110, then an MSB value of 1 is associated with DL TB1, the middle bit value of 1 is associated with UL TB1, and the least significant bit (“LSB”) value of 0 is associated with DL TB2. In various embodiments, bit values from most significant bit (“MSB”) to LSB are first associated with all DL TBs and then followed by UL TB. In such embodiments, according to which an association for FIG. 10 TDRA will be: the MSB value of 1 is associated with DL TB1, the middle bit value of 1 is associated with DL TB2, and the LSB value of 0 is associated with UL TB1 (or the other direction—UL first, DL second).

In certain embodiments, there may be a modulation and coding scheme indication for UL and DL. In some embodiments, a variable size MCS field is indicated by a new unified DCI format with a maximum size depending on a number of TBs scheduled for both UL and DL. In one example, each TB is associated with a separate MCS value.

In various embodiments, a single MCS value is assigned for contiguously scheduled TBs for DL and a separate MCS value of non-contiguous TB for DL. In such embodiments, a similar indication may be assigned for UL. In one example, only two MCS values are assigned where one value is associated with all the TBs in DL and the other value is associated with all the TBs in UL. In certain embodiments, only one MCS value is indicated that is applied across all TBs and for both DL and UL.

In some embodiments, there may be frequency domain resource assignment for UL and DL. In various embodiments, different frequency division resource assignment (“FDRA”) fields are indicated for both UL and DL, where an allocation type may be either the same or different for both UL and DL. In one example, if the same size TB is scheduled for both UL and DL and different MCS is indicated for each direction depending on the channel quality, then a UE may expect to be indicated with different FDRA for both DL and UL. In another example, if the same size TB is scheduled for both UL and DL and same MCS is indicated for each direction, but different TDRA is indicated for each UL and DL, then a UE may expect to be indicated with different FDRA for both DL and UL.

In certain embodiments, a single FDRA is indicated for both UL and DL, where the allocation type is the same for both UL and DL. In one example, if the same size TB is scheduled for both UL and DL and different MCS is indicated for each direction depending up on the channel quality, then a UE may expect to be indicated with same FDRA for both DL and UL only if different TDRA is assigned to match the required MCS. In another example, if the same size TB is scheduled for both UL and DL and same MCS is indicated for each direction, then a UE may expect to be indicated with the same FDRA for both UL and DL only if the same (e.g., single) TDRA is indicated for both UL and DL.

In some embodiments, there may be time domain resource assignment for UL and DL. In various embodiments, different TDRA are indicated based on two separate tables configured for UL and DL. In one example, each of the TDRA tables are independently configured for both UL and DL in terms of a number of SLIVs (e.g., different S+L range as well), mapping types, an indication of a number of TBs (e.g., implicitly or explicitly), an indication of a number of repetitions for one or all of the scheduled TBs. The values indicated by gNB may be such that the UE is not expected to receive any overlapping resources in time between UL and DL.

In certain embodiments, only a single TDRA field is indicated in DCI to determine time-domain resources for all TBs for both UL and DL. In one example, at least two set of SLIVs, mapping types, and/or slot offsets are included in a TDRA table where one set is associated with UL and the other set is associated with DL. An example of such TDRA tables is illustrated in Table 2 and corresponding time-domain multiplexing for DL and UL with multiple TBs is shown in FIG. 10.

TABLE 2
TDRA row index for UL and DL scheduling

| | PDSCH TB1 | | | | PUSCH TB1 | | | | PDSCH TB2 | | | |
|---|---|---|---|---|---|---|---|---|---|---|---|---|
| | Map- | | | | Map- | | | | Map- | | | |
| Row | ping | | | | ping | | | | ping | | | |
| Index | type | S | L | K2 | type | S | L | K2 | type | S | L | K2 |
| 1 | B | 0 | 14 | 1 | B | 0 | 28 | 2 | B | 0 | 28 | 4 |

In some embodiments, only a single set of SLIVs along with single mapping type and single slot offset is included in a TDRA table and a total number of TBs are indicated. In addition, a UE is indicated by higher layer signaling with a round-robin multiplexing (e.g., alternate DL and UL multiplexing). An example of such TDRA tables is illustrated in Table 3 and corresponding time-domain multiplexing for DL and UL with multiple TBs is shown in FIG. 8.

TABLE 3
TDRA row index with single set of SLIV for both UL
and DL and total number of TBs

| Row | | Mapping | | | Number |
|---|---|---|---|---|---|
| Index | K2 | type | S | L | of TBs |
| 1 | 1 | B | 0 | 14 | 5 |

In various embodiments, there may be sidelink scheduling for high SCS. In certain embodiments, there may be a unified SCI format for two-way scheduling in sidelink.

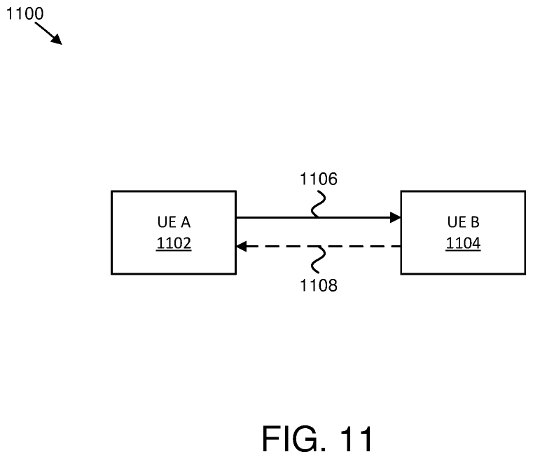

FIG. 11 is a schematic block diagram 1100 illustrating one embodiment of sidelink communications. The block diagram 1100 includes a UE A 1102 and a UE B 1104.

The UE A 1102 may schedule 1106 SL transmission of UE B 1104 together with its SL transmission to UE B 1104 by transmitting a SL grant to be used by UE B 1104 to UE A 1102 in the second stage sidelink control information (“SCI”). The UE B 1104 may transmit a response to the UE A 1102.

In certain embodiments, if UE A performs SL transmission to UE B, UE A may add a SL grant in the second stage SCI that is to be used by UE B for its transmission towards UE A and as part of optimization. The SL grant only indicates the TDRA field in terms of slot offset and FDRA remains the same. In some embodiments, UE A may indicate in a first or in a second stage SCI with a bit (e.g., 1 or 0) whether UE B may use resources reserved by UE A. When this bit is set to true (e.g., “1”) then UE B may use one of those reserved resources indicated in the first stage SCI by UE A provided if the SL transmission from UE A to UE B was ACK and thus the reserved resources are not needed for further retransmission from UE A to UE B.

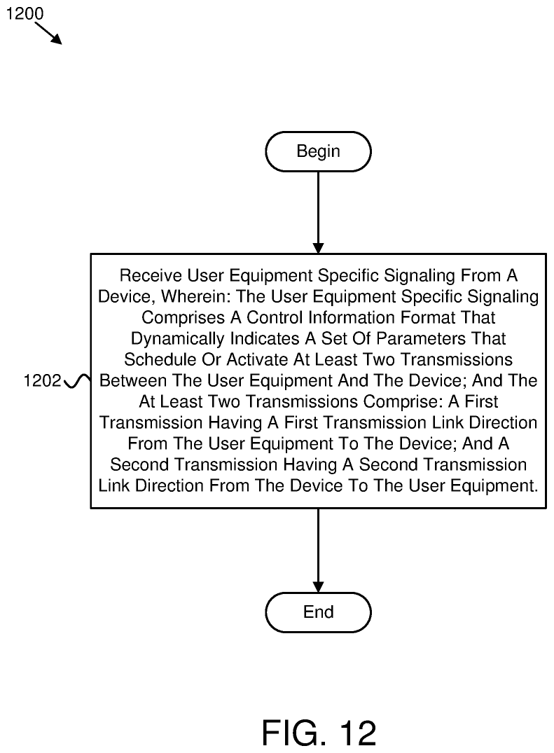

FIG. 12 is a flow chart diagram illustrating one embodiment of a method 1200 for control information that schedules or activates multiple transmissions. In some embodiments, the method 1200 is performed by an apparatus, such as the remote unit 102. In certain embodiments, the method 1200 may be performed by a processor executing program code, for example, a microcontroller, a microprocessor, a CPU, a GPU, an auxiliary processing unit, a FPGA, or the like.

In various embodiments, the method 1200 includes receiving 1202 user equipment specific signaling from a device. The user equipment specific signaling comprises a control information format that dynamically indicates a set of parameters that schedule or activate at least two transmissions between the user equipment and the device; and the at least two transmissions comprise: a first transmission having a first transmission link direction from the user equipment to the device; and a second transmission having a second transmission link direction from the device to the user equipment.

In certain embodiments, the first transmission and the second transmission are transmitted on non-overlapping time-frequency resources. In some embodiments, the control information format schedules a first at least one transport block for downlink transmission across a first at least one transmission time interval and a second at least one transport block for uplink transmission across a second at least one transmission time interval. In various embodiments, a duration of each of the first at least one transmission time interval and the second at least one transmission time interval is less than or equal to one slot.

In one embodiment, time-domain resources for each of the first transmission and the second transmission are indicated by a time-domain resource assignment field in the control information format, and the time-domain resource assignment field indicates an index corresponding to a time-domain resource assignment table configured by higher layer signaling. In certain embodiments, the time-domain resource assignment table comprises at least two sets of parameters, a first set of parameters of the at least two sets of parameters corresponds to time-domain resources for the first transmission, and a second set of parameters of the at least two sets of parameters corresponds to time-domain resources for the second transmission. In some embodiments, parameters of the at least two sets of parameters comprise a slot offset for the at least two transmissions with respect to scheduling a physical downlink control channel transmission, a start symbol within a slot, a length of transmission, a mapping type, or some combination thereof.

In various embodiments, the time-domain resource assignment table indicates a number of transport blocks to be scheduled for each of the first transmission and the second transmission, and the number of transport blocks to be scheduled for each of the first transmission and the second transmission is indicated implicitly by determining a number of start and length indicator values or explicitly by a column field in the time-domain resource assignment table. In one embodiment, the control information format schedules at least one new transport block, a retransmission of at least one old transport block, or a repetition of the at least one new transport block for the first transmission, the second transmission, or a combination thereof. In certain embodiments, the control information format comprises a bit field having a size of two bits to indicate scheduling of first transmission, the transmission, or some combination thereof.

In some embodiments, the control information format comprises a field that indicates bandwidth part switching with variable size for the first transmission and the second transmission. In various embodiments, the control information format comprises a field that indicates demodulation reference signal antenna ports for the first transmission and the second transmission. In one embodiment, in response to a single set of demodulation reference signal antenna ports being indicated for the first transmission and the second transmission, using the same waveform for the first transmission and the second transmission.

In certain embodiments, in response to a single set of demodulation reference signal antenna ports being indicated for the first transmission and the second transmission, using the same subcarrier spacing for the first transmission and the second transmission. In some embodiments, in response to a single set of demodulation reference signal antenna ports being indicated for the first transmission and the second transmission, using the same modulation and coding scheme for the first transmission and the second transmission. In various embodiments, the control information format comprises a field that indicates frequency domain resource assignment with a variable size for the first transmission and the second transmission.

In one embodiment, in response to the frequency domain resource assignment being indicated for the first transmission and the second transmission, configuring the same resource allocation type for the first transmission and the second transmission. In certain embodiments, the device comprises a network device. In some embodiments, the device comprises a second user equipment.

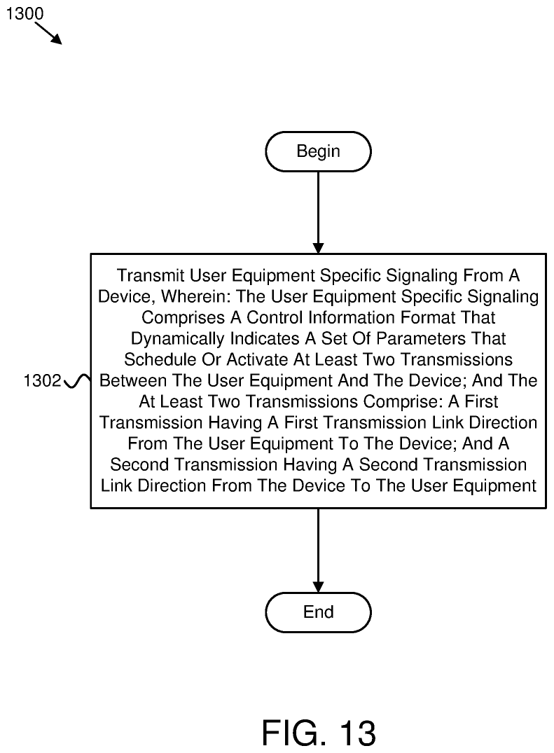

FIG. 13 is a flow chart diagram illustrating one embodiment of a method 1300 for control information that schedules or activates multiple transmissions. In some embodiments, the method 1300 is performed by an apparatus, such as the network unit 104. In certain embodiments, the method 1300 may be performed by a processor executing program code, for example, a microcontroller, a microprocessor, a CPU, a GPU, an auxiliary processing unit, a FPGA, or the like.

In various embodiments, the method 1300 includes transmitting 1302 user equipment specific signaling from a device. The user equipment specific signaling comprises a control information format that dynamically indicates a set of parameters that schedule or activate at least two transmissions between the user equipment and the device; and the at least two transmissions comprise: a first transmission having a first transmission link direction from the user equipment to the device; and a second transmission having a second transmission link direction from the device to the user equipment.

In certain embodiments, the first transmission and the second transmission are transmitted on non-overlapping time-frequency resources. In some embodiments, the control information format schedules a first at least one transport block for downlink transmission across a first at least one transmission time interval and a second at least one transport block for uplink transmission across a second at least one transmission time interval. In various embodiments, a duration of each of the first at least one transmission time interval and the second at least one transmission time interval is less than or equal to one slot.

In one embodiment, time-domain resources for each of the first transmission and the second transmission are indicated by a time-domain resource assignment field in the control information format, and the time-domain resource assignment field indicates an index corresponding to a time-domain resource assignment table configured by higher layer signaling. In certain embodiments, the time-domain resource assignment table comprises at least two sets of parameters, a first set of parameters of the at least two sets of parameters corresponds to time-domain resources for the first transmission, and a second set of parameters of the at least two sets of parameters corresponds to time-domain resources for the second transmission. In some embodiments, parameters of the at least two sets of parameters comprise a slot offset for the at least two transmissions with respect to scheduling a physical downlink control channel transmission, a start symbol within a slot, a length of transmission, a mapping type, or some combination thereof.

In various embodiments, the time-domain resource assignment table indicates a number of transport blocks to be scheduled for each of the first transmission and the second transmission, and the number of transport blocks to be scheduled for each of the first transmission and the second transmission is indicated implicitly by determining a number of start and length indicator values or explicitly by a column field in the time-domain resource assignment table. In one embodiment, the control information format schedules at least one new transport block, a retransmission of at least one old transport block, or a repetition of the at least one new transport block for the first transmission, the second transmission, or a combination thereof. In certain embodiments, the control information format comprises a bit field having a size of two bits to indicate scheduling of first transmission, the transmission, or some combination thereof.

In some embodiments, the control information format comprises a field that indicates bandwidth part switching with variable size for the first transmission and the second transmission. In various embodiments, the control information format comprises a field that indicates demodulation reference signal antenna ports for the first transmission and the second transmission. In one embodiment, in response to a single set of demodulation reference signal antenna ports being indicated for the first transmission and the second transmission, using the same waveform for the first transmission and the second transmission.

In certain embodiments, in response to a single set of demodulation reference signal antenna ports being indicated for the first transmission and the second transmission, using the same subcarrier spacing for the first transmission and the second transmission. In some embodiments, in response to a single set of demodulation reference signal antenna ports being indicated for the first transmission and the second transmission, using the same modulation and coding scheme for the first transmission and the second transmission. In various embodiments, the control information format comprises a field that indicates frequency domain resource assignment with a variable size for the first transmission and the second transmission.

In one embodiment, in response to the frequency domain resource assignment being indicated for the first transmission and the second transmission, configuring the same resource allocation type for the first transmission and the second transmission. In certain embodiments, the device comprises a network device. In some embodiments, the device comprises a second user equipment.

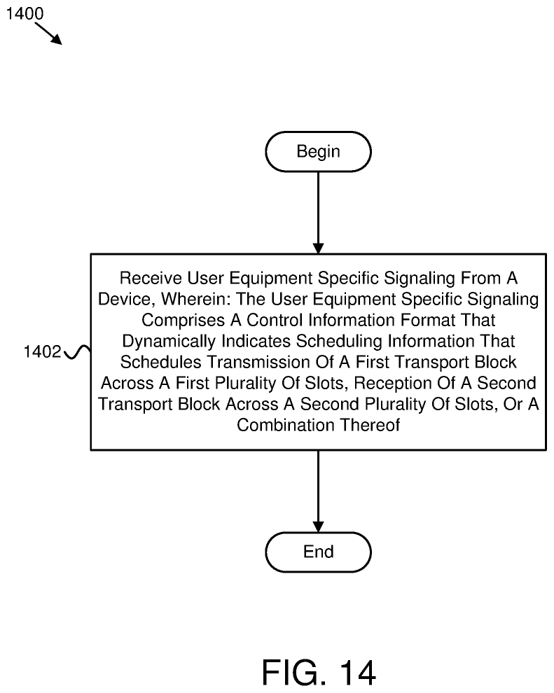

FIG. 14 is a flow chart diagram illustrating one embodiment of a method 1400 for control information that schedules or activates multiple transmissions. In some embodiments, the method 1400 is performed by an apparatus, such as the remote unit 102. In certain embodiments, the method 1400 may be performed by a processor executing program code, for example, a microcontroller, a microprocessor, a CPU, a GPU, an auxiliary processing unit, a FPGA, or the like.

In various embodiments, the method 1400 includes receiving 1402 user equipment specific signaling from a device. The user equipment specific signaling comprises a control information format that dynamically indicates scheduling information that schedules transmission of a first transport block across a first plurality of slots, reception of a second transport block across a second plurality of slots, or a combination thereof.

In certain embodiments, a field in the control information format indicates the scheduling information that schedules transmission of the first transport block across the first plurality of slots, reception of the second transport block across the second plurality of slots, or the combination thereof. In some embodiments, a first field in the control information format indicates the scheduling information that schedules transmission of the first transport block across the first plurality of slots and a second field in the control information format indicates the scheduling information that schedules reception of the second transport block across the second plurality of slots. In various embodiments, the control information format implicitly indicates the scheduling information that schedules transmission of the first transport block across the first plurality of slots, reception of the second transport block across the second plurality of slots, or the combination thereof. In one embodiment, a demodulation reference signal configuration is applied across the first plurality of slots, the second plurality of slots, or a combination thereof.

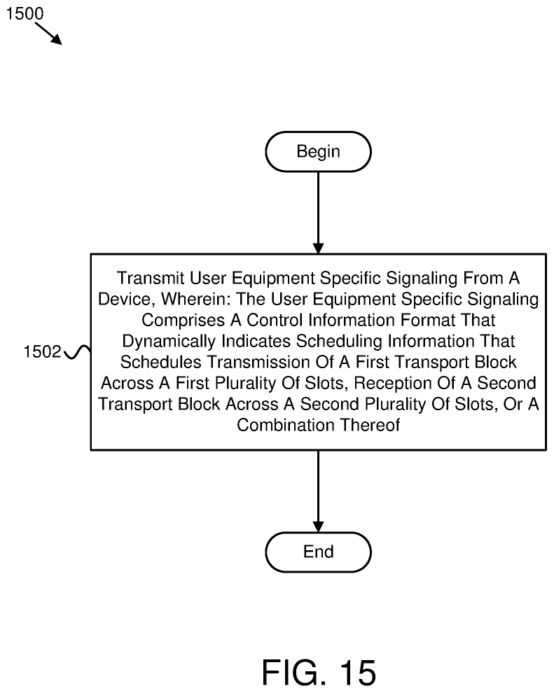

FIG. 15 is a flow chart diagram illustrating one embodiment of a method 1500 for control information that schedules or activates multiple transmissions. In some embodiments, the method 1500 is performed by an apparatus, such as the network unit 104. In certain embodiments, the method 1500 may be performed by a processor executing program code, for example, a microcontroller, a microprocessor, a CPU, a GPU, an auxiliary processing unit, a FPGA, or the like.

In various embodiments, the method 1500 includes transmitting 1502 user equipment specific signaling from a device. The user equipment specific signaling comprises a control information format that dynamically indicates scheduling information that schedules transmission of a first transport block across a first plurality of slots, reception of a second transport block across a second plurality of slots, or a combination thereof.

In certain embodiments, a field in the control information format indicates the scheduling information that schedules transmission of the first transport block across the first plurality of slots, reception of the second transport block across the second plurality of slots, or the combination thereof. In some embodiments, a first field in the control information format indicates the scheduling information that schedules transmission of the first transport block across the first plurality of slots and a second field in the control information format indicates the scheduling information that schedules reception of the second transport block across the second plurality of slots. In various embodiments, the control information format implicitly indicates the scheduling information that schedules transmission of the first transport block across the first plurality of slots, reception of the second transport block across the second plurality of slots, or the combination thereof. In one embodiment, a demodulation reference signal configuration is applied across the first plurality of slots, the second plurality of slots, or a combination thereof.

In one embodiment, a method comprises: receiving user equipment specific signaling from a device, wherein: the user equipment specific signaling comprises a control information format that dynamically indicates a set of parameters that schedule or activate at least two transmissions between the user equipment and the device; and the at least two transmissions comprise: a first transmission having a first transmission link direction from the user equipment to the device; and a second transmission having a second transmission link direction from the device to the user equipment.

In certain embodiments, the first transmission and the second transmission are transmitted on non-overlapping time-frequency resources.

In some embodiments, the control information format schedules a first at least one transport block for downlink transmission across a first at least one transmission time interval and a second at least one transport block for uplink transmission across a second at least one transmission time interval.

In various embodiments, a duration of each of the first at least one transmission time interval and the second at least one transmission time interval is less than or equal to one slot.

In one embodiment, time-domain resources for each of the first transmission and the second transmission are indicated by a time-domain resource assignment field in the control information format, and the time-domain resource assignment field indicates an index corresponding to a time-domain resource assignment table configured by higher layer signaling.

In certain embodiments, the time-domain resource assignment table comprises at least two sets of parameters, a first set of parameters of the at least two sets of parameters corresponds to time-domain resources for the first transmission, and a second set of parameters of the at least two sets of parameters corresponds to time-domain resources for the second transmission.

In some embodiments, parameters of the at least two sets of parameters comprise a slot offset for the at least two transmissions with respect to scheduling a physical downlink control channel transmission, a start symbol within a slot, a length of transmission, a mapping type, or some combination thereof.

In various embodiments, the time-domain resource assignment table indicates a number of transport blocks to be scheduled for each of the first transmission and the second transmission, and the number of transport blocks to be scheduled for each of the first transmission and the second transmission is indicated implicitly by determining a number of start and length indicator values or explicitly by a column field in the time-domain resource assignment table.

In one embodiment, the control information format schedules at least one new transport block, a retransmission of at least one old transport block, or a repetition of the at least one new transport block for the first transmission, the second transmission, or a combination thereof.

In certain embodiments, the control information format comprises a bit field having a size of two bits to indicate scheduling of first transmission, the transmission, or some combination thereof.

In some embodiments, the control information format comprises a field that indicates bandwidth part switching with variable size for the first transmission and the second transmission.

In various embodiments, the control information format comprises a field that indicates demodulation reference signal antenna ports for the first transmission and the second transmission.

In one embodiment, in response to a single set of demodulation reference signal antenna ports being indicated for the first transmission and the second transmission, using the same waveform for the first transmission and the second transmission.

In certain embodiments, in response to a single set of demodulation reference signal antenna ports being indicated for the first transmission and the second transmission, using the same subcarrier spacing for the first transmission and the second transmission.

In some embodiments, in response to a single set of demodulation reference signal antenna ports being indicated for the first transmission and the second transmission, using the same modulation and coding scheme for the first transmission and the second transmission.

In various embodiments, the control information format comprises a field that indicates frequency domain resource assignment with a variable size for the first transmission and the second transmission.

In one embodiment, in response to the frequency domain resource assignment being indicated for the first transmission and the second transmission, configuring the same resource allocation type for the first transmission and the second transmission.

In certain embodiments, the device comprises a network device.

In some embodiments, the device comprises a second user equipment.

In one embodiment, an apparatus comprises: a receiver that receives user equipment specific signaling from a device, wherein: the user equipment specific signaling comprises a control information format that dynamically indicates a set of parameters that schedule or activate at least two transmissions between the user equipment and the device; and the at least two transmissions comprise: a first transmission having a first transmission link direction from the user equipment to the device; and a second transmission having a second transmission link direction from the device to the user equipment.

In certain embodiments, the first transmission and the second transmission are transmitted on non-overlapping time-frequency resources.

In some embodiments, the control information format schedules a first at least one transport block for downlink transmission across a first at least one transmission time interval and a second at least one transport block for uplink transmission across a second at least one transmission time interval.

In various embodiments, a duration of each of the first at least one transmission time interval and the second at least one transmission time interval is less than or equal to one slot.

In one embodiment, time-domain resources for each of the first transmission and the second transmission are indicated by a time-domain resource assignment field in the control information format, and the time-domain resource assignment field indicates an index corresponding to a time-domain resource assignment table configured by higher layer signaling.

In certain embodiments, the time-domain resource assignment table comprises at least two sets of parameters, a first set of parameters of the at least two sets of parameters corresponds to time-domain resources for the first transmission, and a second set of parameters of the at least two sets of parameters corresponds to time-domain resources for the second transmission.

In some embodiments, parameters of the at least two sets of parameters comprise a slot offset for the at least two transmissions with respect to scheduling a physical downlink control channel transmission, a start symbol within a slot, a length of transmission, a mapping type, or some combination thereof.

In various embodiments, the time-domain resource assignment table indicates a number of transport blocks to be scheduled for each of the first transmission and the second transmission, and the number of transport blocks to be scheduled for each of the first transmission and the second transmission is indicated implicitly by determining a number of start and length indicator values or explicitly by a column field in the time-domain resource assignment table.

In one embodiment, the control information format schedules at least one new transport block, a retransmission of at least one old transport block, or a repetition of the at least one new transport block for the first transmission, the second transmission, or a combination thereof.

In certain embodiments, the control information format comprises a bit field having a size of two bits to indicate scheduling of first transmission, the transmission, or some combination thereof.

In some embodiments, the control information format comprises a field that indicates bandwidth part switching with variable size for the first transmission and the second transmission.

In various embodiments, the control information format comprises a field that indicates demodulation reference signal antenna ports for the first transmission and the second transmission.

In one embodiment, the method further comprises a processor, wherein, in response to a single set of demodulation reference signal antenna ports being indicated for the first transmission and the second transmission, the processor uses the same waveform for the first transmission and the second transmission.

In certain embodiments, the method further comprises a processor, wherein, in response to a single set of demodulation reference signal antenna ports being indicated for the first transmission and the second transmission, the processor uses the same subcarrier spacing for the first transmission and the second transmission.

In some embodiments, the method further comprises a processor, wherein, in response to a single set of demodulation reference signal antenna ports being indicated for the first transmission and the second transmission, the processor uses the same modulation and coding scheme for the first transmission and the second transmission.

In various embodiments, the control information format comprises a field that indicates frequency domain resource assignment with a variable size for the first transmission and the second transmission.

In one embodiment, the method further comprises a processor, wherein, in response to the frequency domain resource assignment being indicated for the first transmission and the second transmission, the processor configures the same resource allocation type for the first transmission and the second transmission.

In certain embodiments, the device comprises a network device.

In some embodiments, the device comprises a second user equipment.

In one embodiment, a method comprises: transmitting user equipment specific signaling from a device, wherein: the user equipment specific signaling comprises a control information format that dynamically indicates a set of parameters that schedule or activate at least two transmissions between the user equipment and the device; and the at least two transmissions comprise: a first transmission having a first transmission link direction from the user equipment to the device; and a second transmission having a second transmission link direction from the device to the user equipment.

In certain embodiments, the first transmission and the second transmission are transmitted on non-overlapping time-frequency resources.

In some embodiments, the control information format schedules a first at least one transport block for downlink transmission across a first at least one transmission time interval and a second at least one transport block for uplink transmission across a second at least one transmission time interval.

In various embodiments, a duration of each of the first at least one transmission time interval and the second at least one transmission time interval is less than or equal to one slot.

In one embodiment, time-domain resources for each of the first transmission and the second transmission are indicated by a time-domain resource assignment field in the control information format, and the time-domain resource assignment field indicates an index corresponding to a time-domain resource assignment table configured by higher layer signaling.

In certain embodiments, the time-domain resource assignment table comprises at least two sets of parameters, a first set of parameters of the at least two sets of parameters corresponds to time-domain resources for the first transmission, and a second set of parameters of the at least two sets of parameters corresponds to time-domain resources for the second transmission.

In some embodiments, parameters of the at least two sets of parameters comprise a slot offset for the at least two transmissions with respect to scheduling a physical downlink control channel transmission, a start symbol within a slot, a length of transmission, a mapping type, or some combination thereof.

In various embodiments, the time-domain resource assignment table indicates a number of transport blocks to be scheduled for each of the first transmission and the second transmission, and the number of transport blocks to be scheduled for each of the first transmission and the second transmission is indicated implicitly by determining a number of start and length indicator values or explicitly by a column field in the time-domain resource assignment table.

In one embodiment, the control information format schedules at least one new transport block, a retransmission of at least one old transport block, or a repetition of the at least one new transport block for the first transmission, the second transmission, or a combination thereof.

In certain embodiments, the control information format comprises a bit field having a size of two bits to indicate scheduling of first transmission, the transmission, or some combination thereof.

In some embodiments, the control information format comprises a field that indicates bandwidth part switching with variable size for the first transmission and the second transmission.

In various embodiments, the control information format comprises a field that indicates demodulation reference signal antenna ports for the first transmission and the second transmission.

In one embodiment, in response to a single set of demodulation reference signal antenna ports being indicated for the first transmission and the second transmission, using the same waveform for the first transmission and the second transmission.

In certain embodiments, in response to a single set of demodulation reference signal antenna ports being indicated for the first transmission and the second transmission, using the same subcarrier spacing for the first transmission and the second transmission.

In some embodiments, in response to a single set of demodulation reference signal antenna ports being indicated for the first transmission and the second transmission, using the same modulation and coding scheme for the first transmission and the second transmission.

In various embodiments, the control information format comprises a field that indicates frequency domain resource assignment with a variable size for the first transmission and the second transmission.

In one embodiment, in response to the frequency domain resource assignment being indicated for the first transmission and the second transmission, configuring the same resource allocation type for the first transmission and the second transmission.

In certain embodiments, the device comprises a network device.

In some embodiments, the device comprises a second user equipment.

In one embodiment, an apparatus comprises a device, the apparatus further comprising: a transmitter that transmits user equipment specific signaling from the device, wherein: the user equipment specific signaling comprises a control information format that dynamically indicates a set of parameters that schedule or activate at least two transmissions between the user equipment and the device; and the at least two transmissions comprise: a first transmission having a first transmission link direction from the user equipment to the device; and a second transmission having a second transmission link direction from the device to the user equipment.

In certain embodiments, the first transmission and the second transmission are transmitted on non-overlapping time-frequency resources.

In some embodiments, the control information format schedules a first at least one transport block for downlink transmission across a first at least one transmission time interval and a second at least one transport block for uplink transmission across a second at least one transmission time interval.

In various embodiments, a duration of each of the first at least one transmission time interval and the second at least one transmission time interval is less than or equal to one slot.

In one embodiment, time-domain resources for each of the first transmission and the second transmission are indicated by a time-domain resource assignment field in the control information format, and the time-domain resource assignment field indicates an index corresponding to a time-domain resource assignment table configured by higher layer signaling.

In certain embodiments, the time-domain resource assignment table comprises at least two sets of parameters, a first set of parameters of the at least two sets of parameters corresponds to time-domain resources for the first transmission, and a second set of parameters of the at least two sets of parameters corresponds to time-domain resources for the second transmission.

In some embodiments, parameters of the at least two sets of parameters comprise a slot offset for the at least two transmissions with respect to scheduling a physical downlink control channel transmission, a start symbol within a slot, a length of transmission, a mapping type, or some combination thereof.

In various embodiments, the time-domain resource assignment table indicates a number of transport blocks to be scheduled for each of the first transmission and the second transmission, and the number of transport blocks to be scheduled for each of the first transmission and the second transmission is indicated implicitly by determining a number of start and length indicator values or explicitly by a column field in the time-domain resource assignment table.

In one embodiment, the control information format schedules at least one new transport block, a retransmission of at least one old transport block, or a repetition of the at least one new transport block for the first transmission, the second transmission, or a combination thereof.

In certain embodiments, the control information format comprises a bit field having a size of two bits to indicate scheduling of first transmission, the transmission, or some combination thereof.

In some embodiments, the control information format comprises a field that indicates bandwidth part switching with variable size for the first transmission and the second transmission.

In various embodiments, the control information format comprises a field that indicates demodulation reference signal antenna ports for the first transmission and the second transmission.

In one embodiment, the method further comprises a processor, wherein, in response to a single set of demodulation reference signal antenna ports being indicated for the first transmission and the second transmission, the processor uses the same waveform for the first transmission and the second transmission.

In certain embodiments, the method further comprises a processor, wherein, in response to a single set of demodulation reference signal antenna ports being indicated for the first transmission and the second transmission, the processor uses the same subcarrier spacing for the first transmission and the second transmission.

In some embodiments, the method further comprises a processor, wherein, in response to a single set of demodulation reference signal antenna ports being indicated for the first transmission and the second transmission, the processor uses the same modulation and coding scheme for the first transmission and the second transmission.

In various embodiments, the control information format comprises a field that indicates frequency domain resource assignment with a variable size for the first transmission and the second transmission.

In one embodiment, the method further comprises a processor, wherein, in response to the frequency domain resource assignment being indicated for the first transmission and the second transmission, the processor configures the same resource allocation type for the first transmission and the second transmission.

In certain embodiments, the device comprises a network device.

In some embodiments, the device comprises a second user equipment.

In one embodiment, a method comprises: receiving user equipment specific signaling from a device, wherein: the user equipment specific signaling comprises a control information format that dynamically indicates scheduling information that schedules transmission of a first transport block across a first plurality of slots, reception of a second transport block across a second plurality of slots, or a combination thereof.

In certain embodiments, a field in the control information format indicates the scheduling information that schedules transmission of the first transport block across the first plurality of slots, reception of the second transport block across the second plurality of slots, or the combination thereof.

In some embodiments, a first field in the control information format indicates the scheduling information that schedules transmission of the first transport block across the first plurality of slots and a second field in the control information format indicates the scheduling information that schedules reception of the second transport block across the second plurality of slots.

In various embodiments, the control information format implicitly indicates the scheduling information that schedules transmission of the first transport block across the first plurality of slots, reception of the second transport block across the second plurality of slots, or the combination thereof.

In one embodiment, a demodulation reference signal configuration is applied across the first plurality of slots, the second plurality of slots, or a combination thereof.

In one embodiment, an apparatus comprises: a receiver that receives user equipment specific signaling from a device, wherein: the user equipment specific signaling comprises a control information format that dynamically indicates scheduling information that schedules transmission of a first transport block across a first plurality of slots, reception of a second transport block across a second plurality of slots, or a combination thereof.

In certain embodiments, a field in the control information format indicates the scheduling information that schedules transmission of the first transport block across the first plurality of slots, reception of the second transport block across the second plurality of slots, or the combination thereof.

In some embodiments, a first field in the control information format indicates the scheduling information that schedules transmission of the first transport block across the first plurality of slots and a second field in the control information format indicates the scheduling information that schedules reception of the second transport block across the second plurality of slots.

In various embodiments, the control information format implicitly indicates the scheduling information that schedules transmission of the first transport block across the first plurality of slots, reception of the second transport block across the second plurality of slots, or the combination thereof.

In one embodiment, a demodulation reference signal configuration is applied across the first plurality of slots, the second plurality of slots, or a combination thereof.

In one embodiment, a method comprises: transmitting user equipment specific signaling from a device, wherein: the user equipment specific signaling comprises a control information format that dynamically indicates scheduling information that schedules transmission of a first transport block across a first plurality of slots, reception of a second transport block across a second plurality of slots, or a combination thereof.

In certain embodiments, a field in the control information format indicates the scheduling information that schedules transmission of the first transport block across the first plurality of slots, reception of the second transport block across the second plurality of slots, or the combination thereof.

In some embodiments, a first field in the control information format indicates the scheduling information that schedules transmission of the first transport block across the first plurality of slots and a second field in the control information format indicates the scheduling information that schedules reception of the second transport block across the second plurality of slots.

In various embodiments, the control information format implicitly indicates the scheduling information that schedules transmission of the first transport block across the first plurality of slots, reception of the second transport block across the second plurality of slots, or the combination thereof.

In one embodiment, a demodulation reference signal configuration is applied across the first plurality of slots, the second plurality of slots, or a combination thereof.

In one embodiment, an apparatus comprises a device, the apparatus further comprising: a transmitter that transmits user equipment specific signaling from the device, wherein: the user equipment specific signaling comprises a control information format that dynamically indicates scheduling information that schedules transmission of a first transport block across a first plurality of slots, reception of a second transport block across a second plurality of slots, or a combination thereof.

In certain embodiments, a field in the control information format indicates the scheduling information that schedules transmission of the first transport block across the first plurality of slots, reception of the second transport block across the second plurality of slots, or the combination thereof.

In some embodiments, a first field in the control information format indicates the scheduling information that schedules transmission of the first transport block across the first plurality of slots and a second field in the control information format indicates the scheduling information that schedules reception of the second transport block across the second plurality of slots.

In various embodiments, the control information format implicitly indicates the scheduling information that schedules transmission of the first transport block across the first plurality of slots, reception of the second transport block across the second plurality of slots, or the combination thereof.

In one embodiment, a demodulation reference signal configuration is applied across the first plurality of slots, the second plurality of slots, or a combination thereof.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. (canceled)

2. (canceled)

3. (canceled)

4. (canceled)

5. (canceled)

6. An apparatus comprising:
a receiver that receives user equipment specific signaling from a device, wherein:
the user equipment specific signaling comprises a control information format that dynamically indicates a set of parameters that schedule or activate at least two transmissions between the user equipment and the device; and
the at least two transmissions comprise:
a first transmission having a first transmission link direction from the user equipment to the device; and
a second transmission having a second transmission link direction from the device to the user equipment.

7. The apparatus of claim 6, wherein the control information format schedules a first at least one transport block for downlink transmission across a first at least one transmission time interval and a second at least one transport block for uplink transmission across a second at least one transmission time interval.

8. The apparatus of claim 6, wherein time-domain resources for each of the first transmission and the second transmission are indicated by a time-domain resource assignment field in the control information format, and the time-domain resource assignment field indicates an index corresponding to a time-domain resource assignment table configured by higher layer signaling.

9. The apparatus of claim 6, wherein the control information format schedules at least one new transport block, a retransmission of at least one old transport block, or a repetition of the at least one new transport block for the first transmission, the second transmission, or a combination thereof.

10. The apparatus of claim 6, wherein the device comprises a second user equipment.

11. (canceled)

12. (canceled)

13. An apparatus comprising a network device, the apparatus further comprising:
a transmitter that transmits user equipment specific signaling from the network device, wherein:
the user equipment specific signaling comprises a control information format that dynamically indicates a set of parameters that schedule or activate at least two transmissions between the user equipment and the network device; and
the at least two transmissions comprise:
a first transmission having a first transmission link direction from the user equipment to the network device; and
a second transmission having a second transmission link direction from the network device to the user equipment.

14. The apparatus of claim 13, wherein the control information format schedules a first at least one transport block for downlink transmission across a first at least one transmission time interval and a second at least one transport block for uplink transmission across a second at least one transmission time interval.

15. (canceled)

16. (canceled)

17. An apparatus comprising:
a receiver that receives user equipment specific signaling from a network device, wherein:
the user equipment specific signaling comprises a control information format that dynamically indicates scheduling information that schedules transmission of a first transport block across a first plurality of slots, reception of a second transport block across a second plurality of slots, or a combination thereof.

18. The apparatus of claim 17, wherein a field in the control information format indicates the scheduling information that schedules transmission of the first transport block across the first plurality of slots, reception of the second transport block across the second plurality of slots, or the combination thereof.

19. (canceled)

20. (canceled)
